(19) United States
(12) Patent Application Publication
(10) Pub. No.: US 2005/0002511 A1
(43) Pub. Date: Jan. 6, 2005

(54) Method for activating a call diversion with a compliance request

(76) Inventor: Milan Jeler, Kranj (SI)

Correspondence Address: Siemens Corporation;Intellectual Property Department, 170 Wood Avenue South, Iselin, NJ, 08830, US

(21) Appl. No.: 10/492,274

(22) PCT Filed: Oct. 1, 2002
(86) PCT No.: PCT/DE02/03724

(30) Foreign Application Priority Data
Oct. 9, 2001 (DE) 101 49 720.2

(51) Int. Cl. H04M 3/42

(52) U.S. Cl. 379/211.01; 379/211.02

(57) ABSTRACT

The invention relates to a method and telecommunication system for activating a call diversion, whereby a call is established between a first and a second telecommunication terminal and a command for the call forwarding and at least one call forwarding condition are given by means of the first telecommunication terminal and transmitted to an exchange, where, after receipt of the command and the call forwarding condition the call forwarding from the first to the second telecommunication terminal is activated.

### CROSS REFERENCE TO RELATED APPLICATIONS

This application is the US National Stage of International Application No. PCT/DE02/03724, filed Oct. 1, 2002 and claims the benefit thereof. The International Application claims the benefits of German application No. 10149720.2 filed Oct. 9, 2001, both applications are incorporated by reference herein in their entirety.

### FIELD OF INVENTION

The invention relates to a method for activating a call diversion to a second telecommunication terminal for at least one call arriving at an exchange for a first telecommunication terminal.

Further the invention relates to a telecommunication system which is designed to divert at least one call arriving at an exchange for a first telecommunication terminal to a second telecommunication terminal.

### BACKGROUND OF INVENTION

Call diversion is taken to mean a diversion service in a telecommunication network, for example the PSTN network or the GSM network, which under defined conditions (e.g. busy, call not accepted, forwarding by the owner of the telephone) of the destination telephone dialed, diverts the incoming call to a specific alternate terminal. This mode of operation is usually also referred to as call forwarding.

The ISDN network or digital mobile radio networks offer this call forwarding as a service feature. The call can be forwarded within one's own network but can also be forwarded to other networks; that is from ISDN terminals through to analog telephones or also to radio telephone terminals in mobile radio networks. Calls can be forwarded under various conditions: Calls can thus be forwarded directly, after a time delay, on busy or on no answer. In the first case the call is forwarded directly to the destination terminal. With delayed forwarding, the diversion is undertaken if the call has not been accepted after a specific period of time or after a specific number of rings. For call forwarding the calling party normally pays the call charges as far as the called party, the charges for the second, forwarded call section being mostly charged to the called party. Only one forwarding per connection is possible.

Usually a call diversion is activated for an ISDN telecommunication terminal by pressing a key on the telecommunication terminal in accordance with the keyboard protocol and entering a code as well as the directory number of the telecommunication terminal to which incoming calls are to be diverted.

With digital networks an automatic call diversion can be activated for example by a combination of keys: “**21*0511900 +DlNr.# send key”.

With analog telecommunication terminals a call diversion can also be activated by entering a combination of keys and the directory number of the telecommunication terminal to which the call is to be diverted. The key or combination of keys pressed to activate or deactivate call forwarding is normally referred to by the term hook flash. After hook flash is activated a connection is established to an exchange, in which case an access code for the call forwarding service must also be entered. The number of the terminal to which the incoming call must be diverted from the exchange must then be informed.

The main disadvantage of the known solutions is that the subscriber to whom the terminal is assigned to which the call is diverted cannot be informed about this during the activation of the call diversion. I.e. the subscriber to whom the call is to be diverted has no opportunity to give their approval to the call diversion. In addition the known methods hides the danger that inadvertently—by mistyping—an incorrect number is entered for the terminal to which the call is to be diverted. In addition, with the known solutions for initializing a call diversion, the disadvantage is that it is necessary within a short period to enter a large quantity of numbers—access code, directory number of the second telecommunication terminal—in which case the time available for initiating a call forwarding is limited.

### SUMMARY OF INVENTION

one object of the invention is thus to create a simple-to-implement way of diverting calls which overcomes the above disadvantages.

This object is achieved by a method of the type mentioned at the start in accordance with the invention, in that a call is set up between the first and the second telecommunication terminals and a command is then entered for call forwarding to the second telecommunication terminal along with at least one call forwarding condition via the first telecommunication terminal and transferred to the exchange, which, after receiving the command and the call forwarding condition, activates the diversion of the call from the first to the second telecommunication terminal.

The inventive solution makes it possible, within the framework of activating a call diversion, to establish a voice connection between the telecommunication terminals involved. This means that the subscriber wishing to divert the call to the terminal of another party that he calls can inform this party that he is doing this when he activates the feature. Furthermore the risk of entering an incorrect number for the terminal to which the call is to be diverted can be minimized with the inventive solution.

In a preferred embodiment of the invention at least one telecommunication terminal is an ISDN terminal.

Another variant of the invention provides for at least one of the telecommunication terminals to be an analog telecommunication terminal.

Further advantages can be obtained by entering the command for call forwarding using a separate input unit intended for this purpose.

An especially favorable variant of the invention provides for the directory numbers of the first and the second telecommunication terminal and the call forwarding condition to be stored by the exchange in a memory unit after it receives the call forwarding command.

Furthermore a check can be made by the exchange on the basis of the call forwarding conditions as to whether an incoming call for the first telecommunication terminal is to be diverted to the second telecommunication terminal.

Advantageously the call forwarding condition can be entered in the form of a numeric or alphanumeric code, using a numeric and/or alphanumeric input unit of the first telecommunication terminal.

A telecommunication system of the type mentioned at the start is especially suitable for executing the method in accordance with the invention, said system being designed, after a call is established between the first and the second telecommunication terminal, to transfer to the exchange a forwarding command entered via the first telecommunication terminal to the second telecommunication terminal as well as at least one call forwarding condition, with the exchange being designed, after receipt of the command and the call forwarding condition, to activate the call diversion from the first to the second telecommunication terminal.

Advantageously at least one telecommunication terminal is an ISDN terminal.

In a further variant of the invention at least one telecommunication terminal is an analog telecommunication terminal.

In a preferred embodiment of the invention the first telecommunication terminal features an input unit for entering the command for call forwarding and the call forwarding condition.

Further advantages can be obtained from the fact that the exchange is designed to store the directory number of the first and the second telecommunication terminals in a memory unit after receiving the call forwarding command.

In addition the exchange can be designed to check whether an incoming call for the first telecommunication terminal is to be diverted to the second telecommunication terminal.

Advantageously the first telecommunication terminal features a numeric or alphanumeric entry unit and is designed to accept the call forwarding condition entered in the form of a numeric or alphanumeric code at the input unit.

### BRIEF DESCRIPTION OF THE DRAWINGS

The invention, along with further advantages, will be explained below using a number of nonrestrictive exemplary embodiments which are shown in the drawing. The Figures show the following schematic diagrams:

FIG. 1 a telecommunication system in accordance with the invention;

FIG. 2 A flowchart of the method in accordance with the invention and

FIG. 3 a flowchart of the call forwarding sequence for an incoming call.

### DETAILED DESCRIPTION OF INVENTION

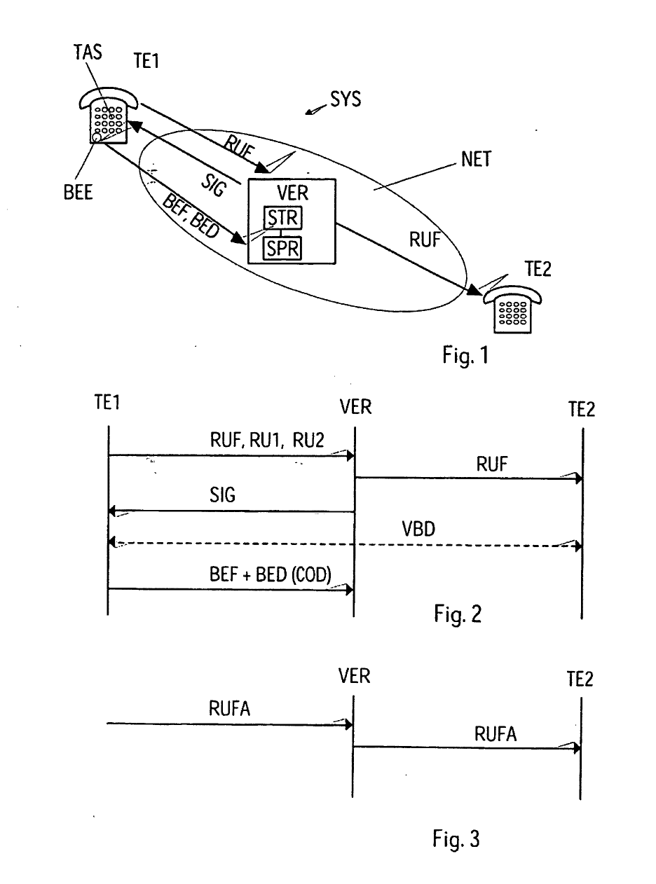

In accordance with FIG. 1 a telecommunication system SYS in accordance with the invention features at least two telecommunication terminals TE1, TE2 which are linked to one another via a telecommunication network NET and an exchange. The telecommunication network NET can for example be an ISDN network, a PSTN or GSM network or a combination of these networks. The telecommunication terminals TE1, TE2 involved can for example be analog or ISDN terminals, but can also be mobile radio terminals.

To activate the forwarding of an incoming call for a first telecommunication terminal TE1 to a second telecommunication terminal TE2 a call setup RUF from the first telecommunication terminal to the telecommunication terminal TE2 is executed. This It is done by entering the directory number RU2 of the second telecommunication terminal via the first telecommunication terminal TE1, for example using a keypad, and transferring it to the exchange VER. Using the transferred directory number RU2 of the second telecommunication terminal TE2, the exchange VER attempts to establish a connection between the two telecommunication terminals TE1, TE2.

As part of the call set-up RUF it is possible that the number called may not be reachable, it may be “busy” for example. The exchange VER thus transfers a free or busy signal to the first telecommunication terminal TE1, depending on the operating state of the called telecommunication terminal TE2. After the free or busy signal SIG is received by this first telecommunication terminal TE1 a command BEF can be entered from this telecommunication terminal TE1 for forwarding the call as well as a forwarding condition BED, for example:“Call forwarding if the number is busy”; “Automatic call forwarding”; “Call forwarding if there is no answer”, and transferred to the exchange VER.

The exchange can feature a controller STR, which is designed, after receiving the command BEF for forwarding the call and the call forwarding condition BED, to activate the can forwarding of incoming calls for the first telecommunication terminal TE1 to the second telecommunication terminal TE2 and to store the call forwarding condition BED as well as a directory numbers RU1, RU2 of the two telecommunication terminals TE1, TE2 in a memory unit SPR. The Controller STR can then use this data stored in the memory unit SPR to divert the call. Combinations of the call forwarding conditions BED are naturally also possible, for example:“Call forwarding if there is no answer” and “Call forwarding when the number is busy”.

The call forwarding conditions BED can be entered as a code COD (FIG. 2) in numeric or alphanumeric form, as is known for example with ISDN telephones. The call forwarding conditions can also correspond to the call forwarding conditions known from the ISDN or GSM services.

The directory number RU1 of the first telecommunication terminal TE1 can be stored for the purposes of the call diversion in the exchange VER together with the directory number RU2 of the telecommunication terminal TE2 to which the call is to be diverted in a memory unit SPR of the exchange VER. In which case a check can be made by the Controller STR on the basis of the directory numbers RU1, RU2 stored in the memory SPR as to whether the incoming call RUFA at the exchange VER (FIG. 3) which is intended for the first telecommunication terminal TE1 is to be diverted.

If a call is to be diverted, the call RUFA can be diverted on the basis of the stored directory number RU2 of the telecommunication terminal to which the call is to be diverted.

A further example will be used below to explain the sequence of the method in accordance with the invention in greater detail.

In accordance with FIG. 2, for the purposes of setting up a call RUF via the first telecommunication terminal, the directory number RU2 of the second telecommunication terminal TE2 is entered and transferred to the exchange VER. In addition to the directory number RU2 of the called telecommunication terminal TE2, the directory number RU1 of the calling telecommunication terminal TE1 can be transferred to the exchange VER.

When this is done the exchange VER can set up a call RUF to the second telecommunication terminal TE2. Depending on the operating state of the second telecommunication terminal TE2, a free or busy signal SIG will be sent by the exchange VER to the first telecommunication terminal TE1.

The command BEF for call forwarding can be entered via the first telecommunication terminal TE1 both after a free or busy signal SIG is received and after the second telecommunication terminal TE2 goes “off-hook”, that is after a connection VBD for message transmission between the two telecommunication terminals TE1, TE2.

An advantage of the invention is now that a subscriber to whose number a call is to be diverted can be informed as part of activation process by the other subscriber wishing to activate the call diversion because there is a speech connection between the two subscribers.

After the command for call forwarding and the call forwarding condition have been entered and transmitted the called subscriber can be released the call for a speech connection.

A successful activation of call forwarding can for example be indicated by a signal provided separately for this purpose which is transferred by the exchange VER to the first telecommunication terminal TE1.

As already explained above, the call forwarding condition BED can be entered in the form of the code COD i.e. in the form of a key combination or sequence using a keypad TAS of telecommunication terminal TE1 (FIG. 1), for example:*1* for automatic call forwarding. Likewise the command BEF can also be entered as a code, for example:**1**. The telecommunication terminal TE1 can however feature a separate input unit BEE provided for entry of the command BEF (FIG. 1), for example in the form of a separate key provided for this purpose.

In accordance with FIG. 3, after call diversion is activated, a call RUFA coming in to the exchange VER intended for the first telecommunication terminal TE1 can be forwarded by the exchange VER to the telecommunication terminal TE2.

1-14. (canceled)

15. A method for activating a call diversion for at least one call for a first telecommunication terminal arriving at an exchange to a second telecommunication terminal, comprising:
setting up a call between the first and the second telecommunication terminal;
entering a command for call forwarding to the second telecommunication terminal as well as entering at least one call forwarding condition via the first telecommunication terminal;
transferring the entered command and the condition to the exchange; and
activating the call diversion from the first to the second telecommunication terminal by the exchange after receiving the command and the call forwarding condition.

16. A method in accordance with claim 15, wherein at least one telecommunications terminal is an ISDN terminal.

17. A method in accordance with claim 15, wherein at least one telecommunication terminal is an analog telecommunication terminal.

18. A method in accordance with claim 15, wherein the command for call forwarding is entered via a separate input unit.

19. A method in accordance with one of the claim 15, wherein directory numbers of the first and the second telecommunication terminals and the call forwarding condition are stored by the exchange after receipt of the call forwarding command in a memory unit.

20. A method in accordance with claim 15, wherein the exchange uses the call forwarding condition to check whether an incoming call for the first telecommunication terminal is to be diverted to the second telecommunication terminal.

21. A method in accordance with claim 15, wherein the call forwarding condition is entered in the form of a numeric or alphanumeric code via a numeric and/or alphanumeric input unit of the first telecommunication terminal.

22. A telecommunication system adapted to divert a call for a first telecommunication terminal arriving at an exchange to a second telecommunication terminal comprising:
a first telecommunication terminal;
a second telecommunication terminal;
an exchange; and
a call setup, wherein
the telecommunication system is adapted, after the call setup to transmit between the first and the second telecommunication terminals a command entered via the first telecommunication terminal to forward the call to the second telecommunication terminal as well as to transfer at least one or call forwarding condition to the exchange, with the exchange is adapted, after receipt of the command and of the call forwarding condition to activate the call diversion from the first to the second telecommunication terminal.

23. A telecommunication system in accordance with claim 22, wherein at least one telecommunication terminal is an ISDN terminal.

24. A telecommunication system in accordance with claim 22, wherein at least one telecommunication terminal is an analog telecommunication terminal.

25. A telecommunication system in accordance with claim 22, the first telecommunication terminal comprises an input unit for entering the command for call forwarding and the call forwarding condition.

26. A telecommunication system in accordance with claim 22, the exchange is adapted to store the directory numbers of the first and the second telecommunication terminals after receipt of the call forwarding command in a memory unit.

27. A telecommunication system in accordance with claim 22, the exchange is adapted to check whether an incoming call for the first telecommunication terminal is to be diverted to the second telecommunication terminal.

28. A telecommunication system in accordance with claim 22, wherein the first telecommunication terminal comprises a numeric or alphanumeric input unit and is adapted to accept the call forwarding condition in the form of a numeric or alphanumeric code via the input unit.

29. A method in accordance with claim 16, wherein at least one telecommunication terminal is an analog telecommunication terminal.

30. A method in accordance with claim 16, wherein the command for call forwarding is entered via a separate input unit provided for this purpose.

31. A telecommunication system in accordance with claim 25, the exchange is adapted to store the directory numbers of the first and the second telecommunication terminals after receipt of the call forwarding command in a memory unit.
